(19) United States
(12) Patent Application Publication
(10) Pub. No.: US 2017/0303558 A1
(43) Pub. Date: Oct. 26, 2017

(54) EXTRUDED PLANT PROTEIN PRODUCT WITH COLOURING PLANT INGREDIENTS AND PRODUCTION METHOD

(71) Applicant: FRAUNHOFER-GESELLSCHAFT ZUR FOERDERUNG DER ANGEWANDTEN FORSCHUNG E.V., Muenchen (DE)

(72) Inventors: PETER EISNER, Freising (DE); RAFFAEL OSEN, Freising (DE)

(21) Appl. No.: 15/541,156

(22) PCT Filed: Jun. 15, 2015
(86) PCT No.: PCT/EP2015/063274

§ 371 Date: Jun. 30, 2017

(30) Foreign Application Priority Data
Jul. 2, 2014 (DE) 10 2014 009 822.2
Mar. 2, 2015 (DE) 10 2015 203 653.7

(51) Int. Cl. A23J 3/22; A23J 1/14; A23P 30/20; A23J 3/14; A23L 11/00

(52) U.S. Cl. CPC A23J 3/227; A23J 3/14; A23L 11/05; A23P 30/20; A23J 1/14

(57) ABSTRACT

The present invention relates to a plant protein product with colouring ingredients and to a production method. In the method, a protein formula is provided which comprises plant proteins from oil seeds or from legumes and oil seeds, and secondary plant compounds from the oil seeds. In this method, the secondary plant compounds from the oil seeds contain polyphenols which alter their colour on oxidation. The polyphenols fraction selected for the protein formula. is between 10 ppm and 0.2%. The protein formula is then extruded at a temperature of more than 100° C. in the presence of atmospheric oxygen. The addition of proteins and of the aforesaid secondary plant compounds from the oil seeds allows different hues to be established in the vegetable extrudate that lend the impression of meat in any of a variety of prepared forms, without any need to add further colorants to the extrudate.

### TECHNICAL FIELD

The present invention relates to wet-textured extrudates containing plant proteins and secondary plant compounds and a method for production thereof.

### PRIOR ART

Extruded products are used extensively in the food industry. The extruder is used primarily to lend the food a specific texture and distinctive mouthfeel. Examples of such include starch-based puffed peanut or corn snacks, dry-extruded proteins and wet-textured products of milk protein or plant protein.

In this context, a wet-textured product is understood to be a product that has been prepared by wet texturing (in this case about 50-70% water). With the application of a suitable processing regimen, wet-textured products are identifiable by a fibrous, texture resembling muscle meat. Wet-texturing is a cooking extrusion process in which the protein- and water-rich matrix is prevented from expanding at the die outlet by use of a cooled die.

Wet-textured products have a water content of about 65%, and they possess a more or less strongly fibrous, meat-like structure depending on the processing regimen in the extruder and cooling die, to such an extent that they are even used as substitutes for beef and poultry. Wet extrusion methods are being used more and more often with plant proteins instead of milk protein in order to provide sustainable alternatives to animal products.

The earliest descriptions of extrusion methods for the production of wet-textured meat substitutes date from the 1970s and 1980s. In the late 1980s and early 90s, further descriptions of wet-texturing appeared in the scientific literature, although these were not directed at manufacturing market-ready products optimised for sensory perception, but rather research into the mechanisms for fibre structure formation.

In recent years, special process conditions, system components and die designs have been described for use with the basic process sequence. For example, WO 2003/007729 A1 describes a method using extra-long barrel extruders and cooling tools which enhance fibre formation. US patent US 20040247760 A1 concentrates more on the die configuration and describes a multichannel design for this component. WO 2009/105654 A1 concerns itself with a protein composition for meat products in the form of gritty granules. The product does not have a fibrous, muscle meat texture. Document WO 2012/158023 A1 describes a wet-texturing method for producing fibrous meat substitutes with particularly high water-absorbing capability, which reaches a juicy consistency when rehydrated to form a broth.

WO 2012/051428 A1 describes not only a wet-texturing method for producing fibrous meat substitutes but also various formulas based on different plant proteins. Artificial or natural colorants are added to modify the colour of the manufactured products.

Until now, vegan products of this kind have been based on isolates from soya and pea protein, occasionally with the addition of wheat gluten to modify the texture and elasticity of the products. The advantage of soya as the main ingredient of the formula is that that soya protein isolates are white in colour, so very pale-coloured, almost white meat substitute products can be derived from them. Thus, a resemblance to poultry flesh can be created even without adding whitening agents such as titanium dioxide. The allergenicity of soya protein and the poor image of soya in Europe has lent a growing impetus to the search alternatives to soya for producing meat substitutes.

One important target parameter for plant-based meat alternatives is the colour of the extrudates. The colour of poultry flesh can already be imitated well with the very pale soya proteins. But a white colour is not desirable for all types of meat. For example, beef and pork are considerably darker, certain varieties exhibit brown, reddish or grey hues and consequently cannot be imitated using soya proteins without the addition of colouring agents. In this respect, much work needs to be done, because many consumers reject the use of colorants in foodstuffs.

The object of the present invention is to provide plant protein extrudates with very uniform, natural, darker colouring and a production method therefor, so that such plant protein extrudates can be used to imitate the visual appearance of darker types of meat.

### DETAILED DISCLOSURE OF THE INVENTION

This object is solved with the extruded plant protein product and the production method therefor according to claims 1 and 7 respectively. Advantageous variations of the plant protein product and the production method therefor are disclosed in the dependent patent claims or may be discerned from the following description and exemplary embodiment.

The suggested extruded plant protein product contains plant proteins from oil seeds or from legumes and oil seeds and secondary plant compounds from the oil seeds. In this context, the secondary plant compounds contain substances from the polyphenol group which change colour upon oxidation, which will be referred to in the following as colouring polyphenols. Examples of such are hydroxycinnamic acids such as sinapinic acid, chlorogenic acid or caffeic acid, and lignanes such as secoisolariciresinol. The plant protein product may also contain further additives. The colouring polyphenols are derived from the same oil seeds as the plant proteins and constitute a fraction of the plant protein product between 10 ppm and 0.2%.

In the production method for a correspondingly coloured plant protein product, a protein formula containing the plant proteins from oil seeds or from legumes and oil seeds as well as secondary plant compounds with the colouring polyphenols from the oil seeds is provided and then extruded. The fraction of colouring polyphenols from the oil seeds in the protein formula is selected to be between 10 ppm and 0.2% depending on the degree to which the colour intensity is to be modified. In the suggested method, the protein formula is extruded at a temperature of more than 100° C. in the presence of atmospheric oxygen.

During research for the present invention, it was found that secondary plant compounds contained in oil seeds may also have a colouring effect in the production of the plant protein extrudates. For this purpose, the secondary plant compounds must contain colouring components such as phenolcarboxylic acids and lignanes from the polyphenols group. These colouring polyphenols are added to the protein formula in low concentrations together with the proteins from the one or more oil seeds used. By appropriate selection of the extrusion conditions (including temperature >100° C., presence of atmospheric oxygen) these colouring polyphenols then alter the colour of the extrudates, so that selective colouring of the manufactured plant protein products may be effected by varying the plant compounds and/or the extrusion conditions. When the colouring polyphenols are added together with the proteins that are also contained as well as the polyphenols in the plant seeds of the respective oil seed, even distribution of the polyphenols and consequently homogeneous colouring may be achieved. A polyphenols fraction of >10 ppm in the protein ingredients is usually undesirable for sensory reasons (smell, taste), so a polyphenols fraction lower than 10 ppm is established as a target in foods containing protein isolates. Therefore, for the purposes of the present invention, ingredients must be used specifically in which the content of colouring polyphenols is high enough to enable the content to be adjusted to >10 ppm in the end product.

The presence of atmospheric oxygen in the extrusion may be assured by various measures, or also by a combination of such measures. For example, the water added for the extrusion may contain a corresponding fraction of (dissolved) oxygen greater than 3 mg/L, and supply the oxygen in this way. A further (preferred) option is to carry out the extrusion in atmospheric air. Finally, the protein formula may also be supplied as a bulk product in which the oxygen fraction is greater than 200 mg per kg protein.

Polyphenols from oil seeds such as sinapinic acid from rapeseed and camelina seeds, chlorogenic acid or caffeic acid from sunflower seeds, or lignanes such as secoisolariciresinol diglycoside from linseed are particularly suitable for use as colouring additives for the suggested plant protein product. Surprisingly, it was found that when these plant compounds are used in the formulas, colouring can be influenced even more effectively by the reaction of the secondary plant compounds under the thermal conditions prevailing during production in the extruder (temperature, time, oxygen fraction).

When compounds of this kind were added in tests, even very low concentrations were found to have considerable colourant effects when the temperature selected for extrusion was above 120° C. Conversely, in higher concentrations a correspondingly pronounced colouring effect could also be induced at lower extrusion temperatures (>100° C.). The results of these colouring effects are particularly advantageous and uniform if the secondary plant compounds are added at the same time as the proteins that are contained in the vegetable seeds as well as the secondary plant compounds, as explained briefly earlier. Thus for example, the colouring derived from chlorogenic acid and caffeic acid in sunflower seeds is distributed particularly evenly in the extrudate if these substances are introduced into the product stream in the extruder, that is to say or before the stream passes through the cooling die, as a mixed extract with sunflower protein in the form of protein meals, concentrates or isolates. This also applies for other oil seeds. In the following, the combination or mixture of secondary plant compounds and proteins of the oil seed(s) used which is added to the protein formula for the colouring effect will also be referred to as the ingredient or protein ingredient.

Accordingly, the corresponding colouring effect in the extrudate can be adjusted very precisely by varying the concentration of this protein ingredient, by altering the temperature-time load on the protein mixture or protein formula, and by precise selection of ingredients with various levels of colorant content, secondary plant compounds and polyphenols. For protein ingredients with a low content of secondary plant compounds, it is only possible to make subtle adjustments in colour at lower temperatures. When ingredients such as protein meals containing a large fraction of secondary plant compounds are used, a very pronounced colouring effect may be achieved even with the addition of low factions of the corresponding ingredient or at lower temperatures. Different raw materials make different colours possible. With sunflower proteins containing chlorogenic acid and caffeic acid, greenich and brownish colour shades are obtained. With rapeseed or camelina protein ingredients which contain sinapinic acid, brownish and grey hues are created. The lignanes and other secondary plant compounds in ingredients from linseed are also able to impart a brownish shade to meat substitute products from plants.

In this way, a range of shades may be set in the plant extrudate to evoke the impression of variously prepared meat products without adding further colorants to the extrudate, simply by adding plant protein ingredients such as meals, concentrates or isolates of rapeseed, sunflower seed, linseed or camelina seed which also contain large enough fractions of the secondary plant compounds occurring in the natural raw substance. Colour effects for simulating beef, poultry flesh or pork, meat that has been marinated or preserved in soya sauce, or meat in ready-to-eat meals such as goulash or stew may thus be created simply by adding a different selection of plant ingredients.

Since the ingredients from rapeseed, sunflower seed, linseed or camelina seed only contain the secondary plant compounds that occur in the natural seed, in this way it is also possible to achieve colour effects without having to publish a statement regarding the colorant substances. This in turn increases consumer acceptance of the meat substitute products compared with products containing artificial colouring additives. Since many of the colouring substances may also trigger an anti-oxidative effect in the body, the addition of the substances in these products also represents a health bonus for the consumer. This also further increases consumer acceptance for the addition of the colouring protein ingredients.

Although many legumes such as soya, peas, lentils or beans do not enjoy very high consumer acceptance due to their sensory effect, allergenicity or a generally negative image, in order to replicate the texture, firmness or colour of the meat substitute products it is often expedient to select formulas that contain soya, peas, lentils or beans as the basic ingredient in the present method as well. Surprisingly, the described colouring ingredients from rapeseed, sunflower seed, linseed or camelina seed were found to have particularly impressive effects in combination with legumes, particularly with pale soya or slightly yellow-greenish pea protein, as was demonstrated in experiments and with a pea extrudate.

### WAYS OF REALISING THE INVENTION

In one embodiment, a pea protein isolate was mixed in one experiment with rapeseed concentrate, in a second experiment with sunflower concentrate and in a third experiment with sunflower meal and with water in each case, and extruded at a temperature of ˜135° C. The protein ingredients constituted 20% relative to the dry mass of the mixture or formula. All ingredients had correspondingly high fractions of colouring polyphenols of >10 ppm.

It was demonstrated that both ingredients from rapeseed and ingredients from sunflower seeds induce very pronounced colour effects. In these cases, the desired colouring may be replicated by varying the concentration of the corresponding ingredient. With phenolic compounds such as chlorogenic acid, the opposite effect is observed. This is to say, more marked green shades are obtained at higher temperatures. The person skilled in the art of food product development is thus able to vary the desired mixed colour using the ingredients listed and the possible colour effects associated with each ingredient.

The use of protein ingredients as the source for the colouring secondary plant compounds has further advantages in addition to those associated with not needing to publish the list of colorants. For example, in the case of sunflower seeds it has been found that the secondary plant compounds contained therein are partially bound to the protein fraction and, so that they only have a particular colouring effect in conjunction with the proteins.

In a further embodiment, a pea protein isolate was this time mixed in one experiment with sunflower meal in a proportion of 5% and in a second and in a second experiment with sunflower meal in a proportion of 10%, and water in each case, and extruded at a temperature of ˜135. Here too, the fractions of 5% and 10% are relative to the dry mass of the mixture or formula. The sunflower meal constituted contained the same fraction of colouring polyphenols in each case, that is to say >10 ppm.

When this embodiment is conducted, it is evident that the change in colour is surprisingly pronounced when some meals are used. For example, very substantial colour effects may be created even with the addition of a low mass % of sunflower or rapeseed meals.

This enables the use of very small quantities of protein ingredient. This in turn ensures that the change in colour does not result in any noticeable changes in the product, such as a noticeable change in the taste or texture of the product.

The colour change is particularly remarkable when the extrudates are roasted. Compared with real roasted meat, it has been found that the addition of rapeseed concentrate results in a coloration similar to roast pork, whereas sunflower meal rather assumes the coloration of roast beef. This enables a very close resemblance to real meat to be obtained simply by adding raw substances from plants.

1. Extruded plant protein product that contains plant proteins from oil seeds or from legumes and oil seeds, as well as secondary plant compounds from the oil seeds, wherein die secondary plant compounds from the oil seeds contain polyphenols which change colour upon oxidation, and the polyphenols constitute a fraction between 10 ppm and 0.2% of the plant protein product.

2. Plant protein product according to claim 1,
characterised in that
the oil seeds are rapeseed and/or linseed and/or sunflower seed and/or camelina seed.

3. Plant protein product according to claim 1,
characterised in that
the secondary plant compounds contain sinapinic acid, chlorogenic acid, caffeic acid or secoisolariciresinol as polyphenols.

4. Plant protein product according to claim 1,
characterised in that
oil seed proteins constitute a fraction of the plant proteins greater than 0.5%.

5. Plant protein product according to claim 1,
characterised in that
oil seed proteins constitute a fraction of the plant proteins greater than 20%.

6. Plant protein product according to claim 1,
characterised in that
vegetable proteins from legumes constitute a fraction of the plant proteins greater than 50%, particularly advantageously greater than 90%.

7. Method for producing a coloured plant protein product, in which a protein formula containing plant proteins from oil seeds or from legumes and oil seeds as well as secondary plant compounds from the oil seeds is provided and then extruded, wherein the secondary plant compounds from the oil seeds contain polyphenols that change colour upon oxidation, a fraction of the polyphenols between 10 ppm and 0.2% is selected in the protein formula, and the protein formula is extruded at a temperature of more than 100° C. in the presence of atmospheric oxygen.

8. Method according to claim 7,
characterised in that
during the extrusion water is added which has a content of dissolved oxygen greater than 3 mg/L.

9. Method according to claim 7,
characterised in that
the extrusion is carried out in atmospheric air.

10. Method according claim 7, characterised in that
the protein formula is supplied as a bulk product in which the oxygen fraction is greater than 200 mg per kg protein.

11. Method according to claim 7,
characterised in that
the protein formula is extruded at a temperature of more than 120° C.

12. Method according to claim 7,
characterised in that
for providing the protein formula a fraction of more than 50% of the plant proteins is formed of legume proteins.

13. Method according to claim 7,
characterised in that
for the provision of the protein formula the plant proteins and secondary plant compounds from the oil seeds are obtained from rapeseed and/or linseed and/or sunflower seed and/or camelina seed.

14. Method according to claim 7,
characterised in that
the plant proteins from the oil seeds are recovered from the oil seeds together with the secondary plant compounds and introduced into the protein formula as a mixed extract of the oil seeds.

15. Plant protein product according to claim 2,
characterized in that
the secondary plant compounds contain sinapinic acid, chlorogenic acid, caffeic acid or secoisolariciresinol as polyphenols.
